(19) United States
(12) Patent Application Publication
(10) Pub. No.: US 2006/0091085 A1
(43) Pub. Date: May 4, 2006

(54) Microchip for sample, centrifugal dispension method of sample using the microchip and centrifugal dispenser

(75) Inventors: Masaaki Kobayashi, Ishikawa-ken (JP); Hiroshi Ichikawa, Kanazawa-shi (JP); Eiichi Tamiya, Kanazawa-shi (JP)

Correspondence Address: KANESAKA BERNER AND PARTNERS LLP, SUITE 300, 1700 DIAGONAL RD, ALEXANDRIA, VA, 22314-2848, US

(73) Assignees: ISHIKAWA SEISAKUSYO, LTD., Kanazawa-shi (JP); Eiichi TAMIYA, Kanazawa-shi (JP)

(21) Appl. No.: 11/256,972

(22) Filed: Oct. 25, 2005

(30) Foreign Application Priority Data
Oct. 28, 2004 (JP) 2004-314645

(51) Int. Cl. C02F 1/38

(52) U.S. Cl. 210/787; 210/512.1; 494/16; 422/72; 436/177

(57) ABSTRACT

A microchip used for a method for centrifugally dispensing a liquid sample by giving a revolving motion and a rotating motion to a rotary disk on which the microchip is mounted, includes a solution-pouring portion at a center thereof onto which the liquid sample is poured and channel patterns extending outward, with the solution-pouring portion as a center, and forming therein flow paths for the liquid sample and detection chambers which constitute portions for examining the liquid sample and in which the liquid sample is centrifugally dispensed. A centrifugal dispensing method using the microchip includes giving a revolving motion and a rotating motion to the rotary disk on which the microchip is mounted, thereby centrifugally dispensing the liquid sample in the detection chambers. A centrifugal dispenser using the microchip includes a rotary disk on which the microchip is mounted, means for revolving the rotary disk about a shaft and means for rotating the rotary disk about another shaft of the rotary disk.

### BACKGROUND OF THE INVENTION

1. Field of the Invention

The present invention relates to a microchip for a sample that performs chemical reaction, biochemical reaction, blood examination, etc. with high efficiency using a minute amount of reaction liquid or a sample, to a centrifugal dispensing method of a sample using the microchip and to a centrifugal dispenser.

2. Description of the Prior Art

A microchip for a sample used when detecting and diagnosing a target gene (DNA), for example, from an infinitesimal sample has therein a flow path (channel pattern) of a microscopic cross section having a specific shape suited for checkup purposes and is used when making a prescribed medical evaluation by feeding a sample liquid under test from a flow-type input port into a channel pattern and making a gene amplification reaction, for example, or when making a prescribed evaluation by filling a channel pattern with a sample and reacting the sample by the application of voltage to the sample. The microchip for a sample includes that having a structure in which a channel pattern is formed in a polymer substrate by the hot embossing using a minute die, by injection molding or by other such processing and attaching a polymer coating sheet or plate to the polymer substrate to seal the channel pattern therein and that having a structure that has a polymer sheet having a channel pattern sandwiched between a pair of coating polymer substrates.

JP-A HEI 8-62225 discloses a microchip for a sample (test unit) having a specimen chamber for receiving a sample, a waste chamber and a prescribed flow path formed therein and also discloses a method for making an assay while rotating the sample about an axis so as to exert a centrifugal force on the sample from the specimen chamber toward the waste chamber and an apparatus for exerting the centrifugal force (refer to FIG. 1 and FIG. 2 thereof). JP-A 2002-3409211 discloses a microchip for a sample that has a stacked body having a plurality of flexible sheets stacked for placing a sample therein and has first to third voids formed therein and also discloses rotation-driving means for exerting a centrifugal force on the sample of the microchip for the sample and moving means for moving the sample thus centrifugally separated. PCT-A 2003-185627 discloses a microchip for a sample for electrophoresis having a channel for separation and a channel for introduction and also discloses a multiple pipetter mechanism having a plurality of pipetter chips 70 attached to the leading end thereof and an electrophoresis capable of operating the pipetter mechanism in the X- and Y-directions (refer to FIG. 2 and FIG. 4 thereof). JP-A 2003-166975 discloses a rectangular chip, in which a channel pattern comprising a plurality of flow paths from one side surface to the other opposite side surface is provided.

In the microchips for a sample forming a prescribed channel pattern as a plurality of flow paths, however, the aforementioned rotating device is required to dispose the microchip for a sample exactly at a position where a centrifugal dispenser is mounted. When the position is slightly displaced, the sample would fail to flow into a prescribed position (into the waste chamber, for example) and flow deviation and possible back-flow will arise, which are problematic. Particularly, an increase in the number of channel patterns makes the width of the flow path narrower, resulting in encountering more difficulty in allowing the sample to run into a prescribed position (into the waste chamber, for example). The microchip for a sample (test unit) of JP-A HEI 8-62225 is required to pour a sample, such as a polymerase chain reaction (PCR) solution, into each of the plurality of channel patterns and also to set the sizes of the specimen chamber and waste chamber and the flow path in detail. Furthermore, this microchip has encountered the case where the sample even when rotated by the rotating device cannot be poured into a prescribed position (into the waste chamber, for example). To be specific, when plural radial channel patterns are formed as slightly deviated from their center, there are cases where the microchip is not disposed exactly at the position where the centrifugal dispenser is mounted, as described above, and where the sample cannot be poured uniformly into the prescribed position due to deviation of the shaft of the motor that is rotation-driving means. In order to make an assay using a conventional microchip for a sample, use of a large-sized expensive spotter device (the aforementioned multiple pipetter mechanism) and a mechanism for precisely moving the device in the X- and Y-directions is required, resulting in the place and equipment on a grand scale and high cost.

In view of the above, one object of the present invention is to provide a microchip for a liquid sample, such as blood, a PCR solution, etc., that enables the specimen to be flow into plural chambers with exactitude for a short period of time in spite of one spot pouring, a centrifugal dispensing method of the sample using the microchip and a centrifugal dispenser.

### SUMMARY OF THE INVENTION

To attain the above object, the present invention provides as a first aspect thereof a microchip used for a method for centrifugally dispensing a liquid sample by giving a revolving motion and a rotating motion to a rotary disk on which the microchip is mounted, comprising a solution-pouring portion at a center thereof onto which the liquid sample is poured and channel patterns extending outward, with the solution-pouring portion as a center, and forming therein flow paths for the liquid sample and detection chambers which constitute portions for examining the liquid sample and in which the liquid sample is centrifugally dispensed.

According to this aspect of the invention, by pouring the sample onto the solution-pouring portion at the center of the microchip for the sample and affording to the rotary disk a sun-and-planet rotation, i.e. both a revolving motion and a rotating motion, the sample is dispensed into each of the channel patterns. Thus, it can be obviated to form a solution-dropping portion on every-one channel pattern as in the prior art. Also according to this aspect of the invention, by filling the solution-dropping portion of the microchip for the sample mounted on the rotary disk with the liquid sample and by means of the sun-and-planet rotation giving the revolving motion and rotating motion to the rotary disk, even in the case where a plurality of radial channel patters are slightly deviated from the center of the rotary disk, where the microchip is not accurately disposed at the mounting position of the centrifugal dispenser as described above or where the shaft of the motor that is the drive means is deviated, for example, the liquid sample can uniformly be poured into each detection chamber of each channel pattern as being separated from each other (dispensed into each detection chamber).

In the second aspect of the invention that includes the first aspect thereof, the channel patterns extend radially and equidistantly and are wider than the flow paths.

According to the second aspect of the invention, by means of the sun-and-planet rotation giving a revolving motion and a rotating motion to the rotary disk, the liquid sample dropped onto the solution-dropping portion, upon receiving both the centrifugal forces of the revolving motion and rotating motion, can uniformly be separated and poured (dispensed) into each detection chamber for a short period of time in the form of flowing into it.

The present invention further provides as a third aspect thereof a method for centrifugally dispensing a liquid sample comprising the steps of using a microchip comprising a solution-pouring portion at a center thereof onto which the liquid sample is poured and channel patterns extending outward, with the solution-pouring portion as a center, and forming therein flow paths for the liquid sample and detection chambers which constitute portions for examining the liquid sample and in which the liquid sample is centrifugally dispensed and giving a revolving motion and a rotating motion to a rotary disk on which the microchip is mounted, thereby centrifugally dispensing the liquid sample in the detection chambers.

According to the third aspect of the invention, by pouring the sample onto the solution-pouring portion at the center of the microchip for the sample and affording to the rotary disk a sun-and-planet rotation, i.e. both a revolving motion and a rotating motion, the sample is dispensed into each of the channel patterns. Thus, it can be obviated to form a solution-dropping portion on every-one channel pattern as in the prior art. Also according to this aspect of the invention, by filling the solution-dropping portion of the microchip for the sample mounted on the rotary disk with the liquid sample and by means of the sun-and-planet rotation giving the revolving motion and rotating motion to the rotary disk, even in the case where a plurality of radial channel patters are slightly deviated from the center of the rotary disk, where the microchip is not accurately disposed at the mounting position of the centrifugal dispenser as described above or where the shaft of the motor that is the drive means is deviated, for example, the liquid sample can uniformly be poured into each detection chamber of each channel pattern as being separated from each other.

The present invention also provides as the fourth aspect thereof a centrifugal dispenser using a microchip comprising a solution-pouring portion at a center thereof onto which the liquid sample is poured and channel patterns extending outward, with the solution-pouring portion as a center, and forming therein flow paths for the liquid sample and detection chambers which constitute portions for examining the liquid sample and in which the liquid sample is centrifugally dispensed, which dispenser comprises a rotary disk on which the microchip is mounted, means for revolving the rotary disk about a shaft and means for rotating the rotary disk about another shaft of the rotary disk. Here, the means for revolving the rotary disk and means for rotating the rotary disk may be either the same means or different means.

According to the fourth aspect of the invention, by filling the solution-dropping portion of the microchip mounted on the rotary disk with a liquid sample, revolving the rotary disk about the shaft as a center with the means for revolving and rotating the rotary disk about the shaft thereof as a center with the means for rotating, the sun-and-planet rotation enables the liquid sample to be uniformly poured into each detection chamber as being separated from each other.

In the fifth aspect of the invention that includes the fourth aspect thereof, the means for revolving the rotary disk comprises a drive means and an arm which is rotated about the shaft by the drive means and on which the rotary disk is mounted, and the means for rotating the rotary disk comprises a gear formed on a periphery of the rotary disk and another gear formed at a center of the arm as suspended from the center for engaging with the gear, or outside revolving motion, wherein the revolving of the rotary disk is given by the rotating of the arm and the rotating of the rotary disk is given by the engaging of the gear with the another gear.

According to the fifth aspect of the invention, the revolving motion about the central gear and rotating motion about the shaft of the rotary disk are given to the rotary disk by the drive means. In addition, by disposing the central gear at the center of the arm as suspended from the center and in alignment with the shaft of the drive means, it is made possible to stabilize the sun-and-planet rotation and reduce the centrifugal dispenser in volume.

The microchip of the present invention for a liquid sample is only required to pour the liquid sample onto the solution-dropping portion at the center thereof. By giving a revolving motion and a rotating motion to the rotary disk on which the microchip is mounted using the centrifugal dispensing method of the sample and the centrifugal dispenser according to the present invention, the sample can uniformly be dispensed into each detection chamber for a short period of time without inducing the variation in the amount of the sample in the detection chambers and the back-flow of the sample. Furthermore, this uniform dispensing can be attained even in the case where plurality of radial channel patterns are slightly deviated from the center of the rotary disk, where the microchip is not accurately disposed at the mounting position of the centrifugal dispenser or where the shaft of the motor that is the drive means is deviated. In spite of the relatively simple structure of the centrifugal dispenser comprising the arm rotated by the drive means, the rotary disk provided with the peripheral gear and the central gear engaging with the peripheral gear, use of the conventional expensive spotter device large in size is not required and the drive means can give a revolving motion and a rotating motion to the rotary disk. This is very advantageous.

The above and other objects, characteristic features and advantages of the present invention will become apparent to those skilled in the art from the description given herein below with reference to the accompanying drawings.

### BRIEF DESCRIPTION OF THE DRAWINGS

FIG. 1 is a plan view showing an example of a microchip for a sample according to the present invention.

FIG. 2 is a plan view showing another example of a microchip for a sample according to the present invention.

FIG. 3 is a plan view showing still another example of a microchip for a sample according to the present invention.

FIG. 4 is a plan view showing yet another example of a microchip for a sample according to the present invention.

FIG. 5 is a perspective view showing a centrifugal dispenser according to the present invention.

FIG. 6 is a explanatory plan view showing the interior structure of the centrifugal dispenser.

FIG. 7 is a plan view showing the centrifugal dispenser.

FIG. 8 is a cross section showing the centrifugal dispenser.

FIG. 9(a) to FIG. 9(c) are explanatory views showing a dispensing process according to the present invention.

FIG. 10(a) to FIG. 10(d) are explanatory views showing another dispensing process according to the present invention.

FIG. 11 shows another centrifugal dispenser according to the present invention, FIG. 11(a) being a plan view thereof and FIG. 11(b) being a cross section thereof.

FIG. 12 shows still another centrifugal dispenser according to the present invention, FIG. 12(a) being a plan view thereof and FIG. 12(b) being a cross section thereof.

FIG. 13 is an explanatory view showing one example of the size of the microchip for a sample according to the present invention.

FIG. 14 is a diagram showing the results of the experiment in Comparative Example 2.

FIG. 15 is an explanatory graph showing the results of detection of an SRY gene.

### DETAILED DESCRIPTION OF THE PREFERRED EMBODIMENT

Embodiments of the present invention will be described in detail with reference to the accompanying drawings.

Each of the microchips of the embodiments for a liquid sample has a circular or square contour and comprises a solution-dropping portion C at the center thereof, a plurality of channel patterns Cp that form therein a flow path and a chamber for the sample and radially extend outward from the solution-dropping portion and an input port Q or input ports S1 formed at the center part of the solution-dropping portion functioning as an inlet or inlets for the sample poured (FIG. 1 through FIG. 4).

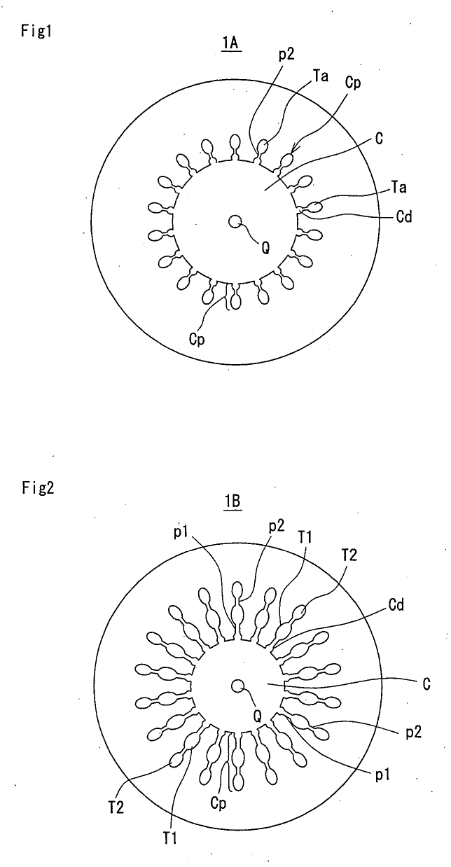

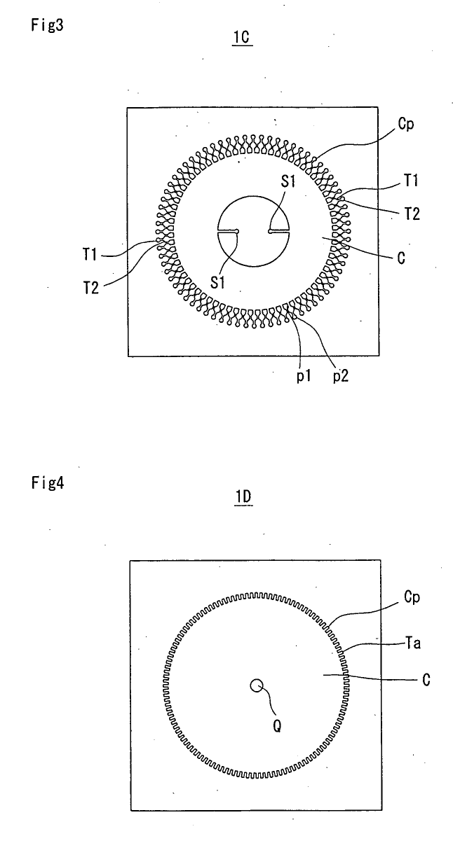

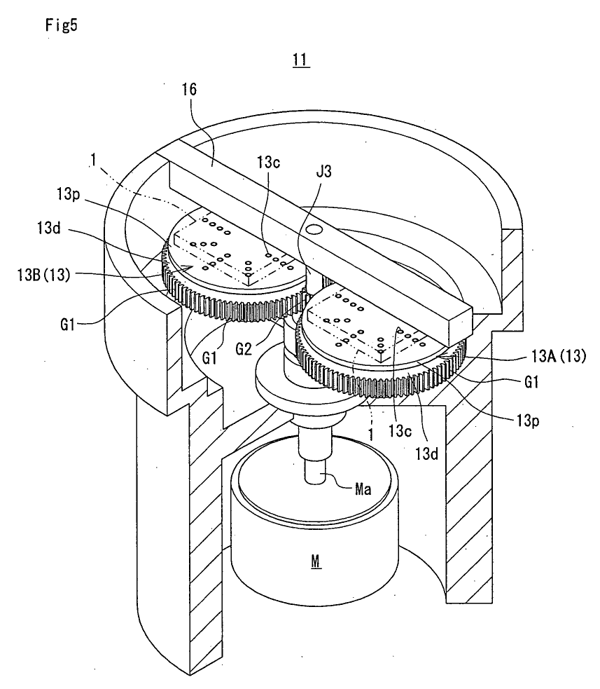

While the microchips 1A and 1B shown in FIGS. 1 and 2 each have 18 channel patterns Cp, that 1C shown in FIG. 3 has 72 channel patterns Cp and that 1D shown in FIG. 4 has 120 channel patterns. In the microchips 1A and 1D shown in FIGS. 1 and 4, each channel pattern has a detection chamber Ta, whereas each channel pattern of the microchips 1B and 1C shown in FIGS. 2 and 3 has a first detection chamber T1 and a second detection chamber T2 outside the first detection chamber. Each connection portion Cd for the solution-dropping portion C and each channel pattern Cp is fan-shaped to facilitate sending the sample to the first and second detection chambers T1 and T2. In the microchip 1C shown in FIG. 3, the central solution-dropping portion C is donut-shaped and has an convex island at the center thereof where the input ports S1 face each other. In the microchips 1B and 1C shown in FIGS. 2 and 3, each channel pattern Cp has a first flow path p1 formed between the connection portion Cd and the first detection chamber T1 and a second flow path formed between the first detection chamber T1 and the second detection chamber T2 and made narrower than the first flow path T1. The microchip 1D shown in FIG. 4 assumes a form seeking to maximize the number of channel patterns Cp in which the channel patterns Cp are concavo-convex and the concave portions constitute the detection chambers Ta. Incidentally, the microchip 1E shown in FIG. 13 has substantially the same structure as the microchip 1A shown in FIG. 1 though being different in the shapes of the detection chamber Ta, flow path p2, etc.

The microchips 1A to 1D for a sample can be fabricated using a hot embossing apparatus to thermally transfer minute flow paths processed into a concavo-convex shape onto the surface of an inexpensive polymer base material, metal or glass. A microchip of polydimethylsiloxane (PDMS) for a sample having minute flow paths can also be fabricated using the semiconductor lithography technique utilizing a mask etc. Other methods for the fabrication include the reactive ion etching (RIE), a laser and an NC processing machine, for example. Here, rapid prototyping was used to produce on an Si wafer a casting mold coated with a pressurized film photoresist (SU-8) that was transferred onto PDMS, whereas a polymer base material (upper chip) on which channel patterns Cp forming flow paths were formed was formed. The S1 wafer and polymer base material were attached by means of an O₂ plasma to produce a microchip 1 for a sample. The microchip 1 for a sample thus fabricated measures about 40 mm×about 40 mm in the case of square ones and 40 mm in diameter and 3 mm in thickness in the case of circular ones. The depth of the flow path was set to be 120 μm and the amount of the sample required for a microchip having 180 channel patterns to be about 8 μl (microliter). As the polymer base material other than PDMS usable in the present invention, general-purpose resin materials, such as acryl, polypropylene, polyethylene, polystyrene, cycloolefin polymer, polycarbonate, can be cited.

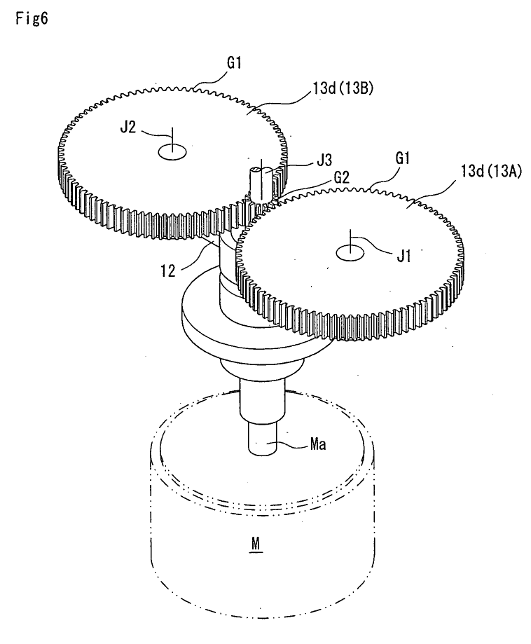

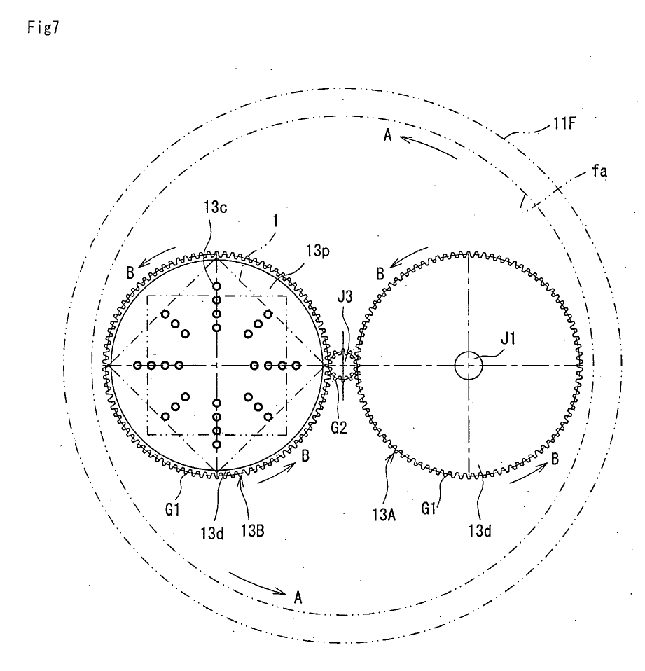

A centrifugal dispenser 11 of a sample using the microchips 1 for the sample will be described with reference to FIGS. 5 to 8. It comprises a cylindrical casing of stainless steel, drive means M in the casing, a rotation arm 12 driven by the drive means, rotary disks 13A and 13B which are disposed above the arm and provided each with a peripheral gear G1 and on each of which the microchip 1 is mounted, and a central stationary gear G2 engaging with the peripheral gears G1. The casing has a diameter of around 20 cm and a size capable of being easily carried, with the top thereof covered with a lid or the like, and has an upper circumferential side 11F (FIG. 7) wider than the lower circumferential side in which the drive means is accommodated. Incidentally, a gear may be formed on a side fa inside the upper circumferential side 11F, which side fa is outside the revolving motion.

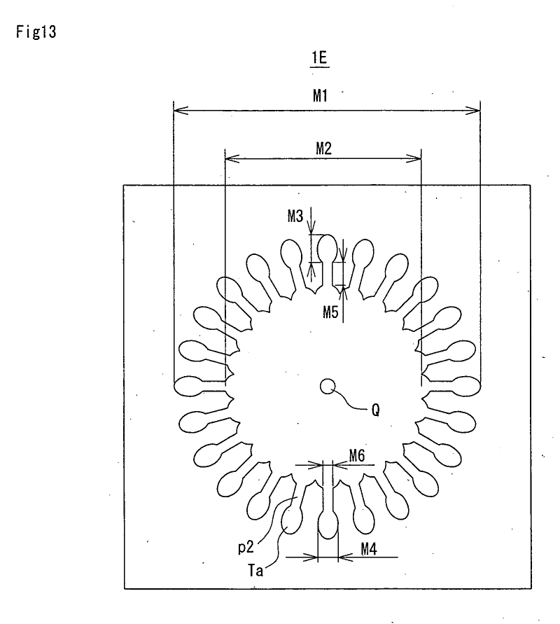

The arm 12 has a center portion connected to a shaft Ma of the drive means M that is a motor and right and left portions connected respectively to the rotary disks 13A and 13B. The arm 12 is provided at the right and left connection parts with bearings rotatably retaining the rotary disks 13A and 13B for permitting the rotation of the disks relative to the arm 12. Thus, the drive means M is used to rotate the arm 12, thereby rotating the two rotary disks 13A and 13B about the shaft Ma of the drive means M. Here, the arm 12 rotated by the drive means M and the rotary disks 13A and 13B attached to the arm 12 are means given a revolving motion, and means given a rotating motion can be realized utilizing the means given a revolving motion or independent rotation driving means (FIG. 11(b)).

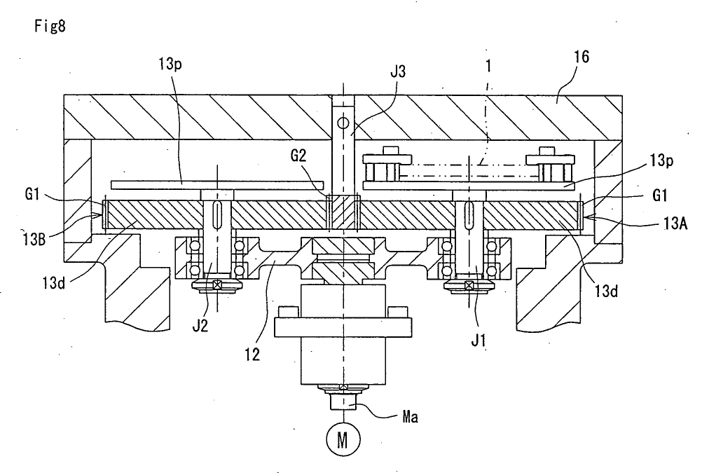

Each of the first rotary disk 13A and the second rotary disk 13B connected to the arm 12 comprises a steel base 13d and a plate 13p disposed on the base 13d and formed with radial positioning holes 13c. A microchip 1 can be positioned on the base 13d, with a pin and a fixation jig, a binder or the like (not shown) inserted into the positioning holes 13c (FIGS. 7 and 8). To facilitate mounting of the microchip 1 on the rotary disk 13, positioning marks or grooves may be formed on the rotary disk 13. Otherwise, a double-faced adhesive tape is used to mount the microchip 1 for a sample on the rotary disk 13. The base 13d of each of the rotary disks 13A and 13B has the peripheral gear G1 as a gear on one side.

The cylindrical casing is provided on the top thereof with a suspension member 16 to bridge the casing for suspending the central gear G2 (formed on the periphery of a shaft J3) so that the central gear is positioned above the shaft Ma of the motor M. The central gear G2 engages with the peripheral gears G1 of the first and second rotary disks 13A and 13B and rotates the disks about a first shaft J1 and a second shaft J2, respectively. The axis of the central gear G2 conforms to the axis of the shaft Ma of the motor M. The central gear G2 has a diameter of 10 mm, each of the first and second rotary disks 13A and 13B has a diameter of 80 mm slightly smaller than one second of the inside diameter of the cylindrical casing. For this reason, when the first and second rotary disks 13A and 13B revolve one time about the central axis G2, they rotate by ⅛ about the first and second shafts J1 and J2, respectively.

The aforementioned planet rotation can be attained when providing the centrifugal dispenser with drive means M1 and M2 for rotating the rotary disks 13A and 13B as shown in FIG, 11(b) independently of the drive means M for driving the arm 12. In the present embodiment, though a structure in which the peripheral gears G1 of the rotary disks (gears on one side) G1 engage with the central gear G1 (a gear on the other side) has been adopted, it is conceivable that as transmission means for connection to the rotating rotary disks 13A and 13B a belt pulley, a chain belt is used. This is included in the present invention.

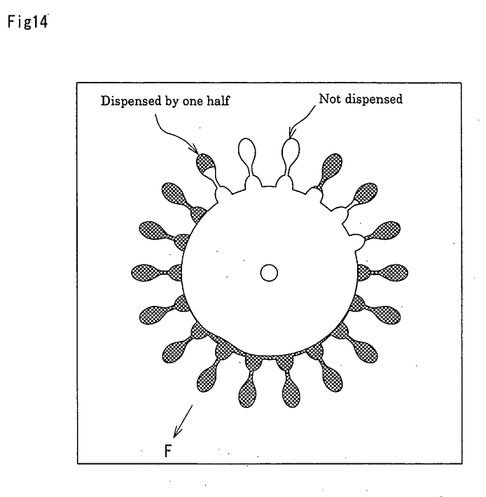

Accordingly, the arm 12 is rotated by the drive means M about the shaft Ma of the motor M. This rotation is a revolving motion with the central gear G2 as a center (in the direction of arrow A in FIG. 7). When this revolving motion A has arisen, since the peripheral gears G1 of the rotary disks engage with the central gear G1, the rotary disks 13A and 13B are rotated about their center shafts J1 and J2, respectively. Each rotation of the rotary disks is a rotating motion (in the direction of arrow B in FIG. 7). This kind of rotation making the revolving motion while making the rotating motion is called a “sun-and-planet rotation.” This sun-and-planet rotation can also be attained using one drive means, in which the cylindrical casing is provided on the inner circumference thereof with an inside gear (FIG. 12) in place of the provision of the central gear G2, which inside gear is allowed to engage with the peripheral gears G1 of the rotary disks 13A and 13B. While provision of both the central gear G2 and the inside gear is possible, provision of the central gear G2 is more effective from the standpoint of size reduction of the sun-and-planet rotation structure than provision of the inside gear. Furthermore, since the central gear G2 conforms in position to the shaft Ma of the motor M, the sun-and-planet rotation can be stabilized and the motor shaft Ma can be suppressed from deviating. It is noted that provision of both gears makes the entire structure complicated and possibly fails to acquire a smooth motion.

It was tested whether a sample could be uniformly separated and poured into the first detection chamber T1 even when the microchip 1B for a sample (FIG. 2) is mounted on each of the rotary disks 13A and 13B and disposed as slightly deviated from the positions of the shafts J1 and J2. Here, 20 μl of a sample is dropped onto the microchip 1B for a sample, and the microchip is rotated at 1500 rpm to dispense the sample into the second detection chambers T2 disposed on the outer side. When the motor M has been driven, the arm 12 is rotated about the shaft Ma of the motor M and this rotation is a revolving motion about the central gear G2 (in the direction of arrow A in FIG. 7). When this revolving motion A has arisen, since the central gear G2 stationarily disposed engages with the peripheral gears G1 of the rotary disks 13A and 13B, the first and second rotary disks 13A and 13B are rotated about the shafts J1 and J2, respectively, and each rotation thereof is a rotating motion (in the direction of arrow B in FIG. 7). The centrifugal force resulting from these revolving and rotating motions causes the sample to be disposed uniformly in the detection chambers T2. In case where mineral oil is brought to the second detection chambers T2 by dropping the mineral oil onto the solution dropping portion C and giving a rotation drive thereto and then a sample is dropped onto the solution dropping portion C and given the same rotation drive, owing to the difference in gravity between the mineral oil and the sample, the mineral oil in the second detection chambers T2 can be substituted for the sample, and the mineral oil can be dispensed into the first detection chambers T1. This means that the microchip can be applied to a gene test utilizing the gene amplification method (PCR etc.).

The principle of enabling the separation and pouring (dispensing) of a sample will be described hereinafter. Since the microchips 1A makes a rotation motion, the centrifugal force thereof urges the sample to move toward the outer peripheries of the microchips. However, it is impossible only with this rotating motion to dispose the sample on all the detection chambers T1 and T2 because of the presence of resistance of the solution entering the minute flow paths (flow path resistance). However, since the microchips 1A receive the centrifugal force of the revolving motion (the speeds of the rotating and revolving motions being controlled in advance so that the centrifugal force of the latter may be larger than that of the former), the detection chambers T1 and T2 invariably vary in shape to enable the solution, such as a PCR solution, to be uniformly disposed on all the detection chambers T1 and T2. Even in cases where the microchips cannot accurately be mounted on the centers of the rotary disks 13A and 13B of the centrifugal dispenser, where the plural radial channel patterns Cp are formed as being deviated slightly from the center of the microchip and where the shaft Ma of the motor M that is the drive means happens to deviate, the sun-and-planet rotation enables the sample to be uniformly dispensed onto the detection chambers. Though an increase in number of the channel patterns will make the widths of the flow paths narrower and accurate formation thereof difficult (the flow paths being possibly formed with deviation), according to the embodiment of the present invention, it is conceivable that the probability of the sample being uniformly dispensed onto all the detection chambers T1 and T2 will become high. Incidentally, only with the rotating motion it is impossible to uniformly dispose the sample on the detection chambers, and this is the case only with the revolving motion because the centrifugal force thereof is exerted only in one direction from the center of the revolving motion.

Examples and comparative examples using a PCR solution will be described hereinafter.

### EXAMPLE 1

The PCR is the abbreviation of a polymerase chain reaction that is the technology for replicating, based on a specific gene arrangement, the gene million-fold for a short period of time. It has recently been subjected to utilization when diagnosing and detecting a genetically determined disease, virus or bacillus from blood, marrow liquid, cerebrospinalis liquid, etc. besides the utilization in the bioengineering field. By analyzing the process of this production, it is possible to determine the quantity of the DNA content itself. The PCR comprises the following six procedures, i.e. of (1) extracting a DNA, (2) heating a DNA double helix to form a single-strand DNA, (3) allowing the gene comprising four bases to be bonded with a specific base, (4) preparing a target gene based on this base sequence that is the gene arrangement and adding thereto a gene fragment (primer) paired with the target gene, (5) allowing the primer to be bonded with the gene arrangement aimed at and (6) using a heat-stable enzyme (Taq enzyme) to reproduce the original DNA double helix from the position of bond when the primer is bonded to single-strand DNA.

From the one DNA double helix during the course of this process, two same DNA double helixes are produced. These helixes are heated to form single-strand DNAs that are added with a primer to reproduce DNAs, with the result that four DNA double helixes can be produced. By repeating this process in this way, DNAs produced are exponentially increased. A series of these processes are continuously repeated, with the temperature accurately controlled with an apparatus called a thermal cycler.

In the conventional reaction detection using the PCR based on the technology described above, a spotter device is used to dispose some kinds of primers on the detection points (detection chambers, etc.) and then to drop a PCR solution onto the detection points, a polymer base material and an Si water are attached to each other and a heater is used for accurately controlling the temperature of the detection chambers to perform amplification of a DNA, thereby detecting the reaction results. The amount of each of the primer and PCR solution poured with the spotter device is required to be minute and quantitative in terms of a unit of nano-liter or pico-liter, and PCR solutions are required to be in non-contact with the adjacent chambers (to be poured as separated). Incidentally, in the reaction of a primer with a PCR solution, there is a case where the temperature has to be elevated to a prescribed temperature in the PCR. Incidentally, in the reaction of a primer with a PCR solution, there is a case where the temperature in the PCR is to be elevated to a prescribed temperature.

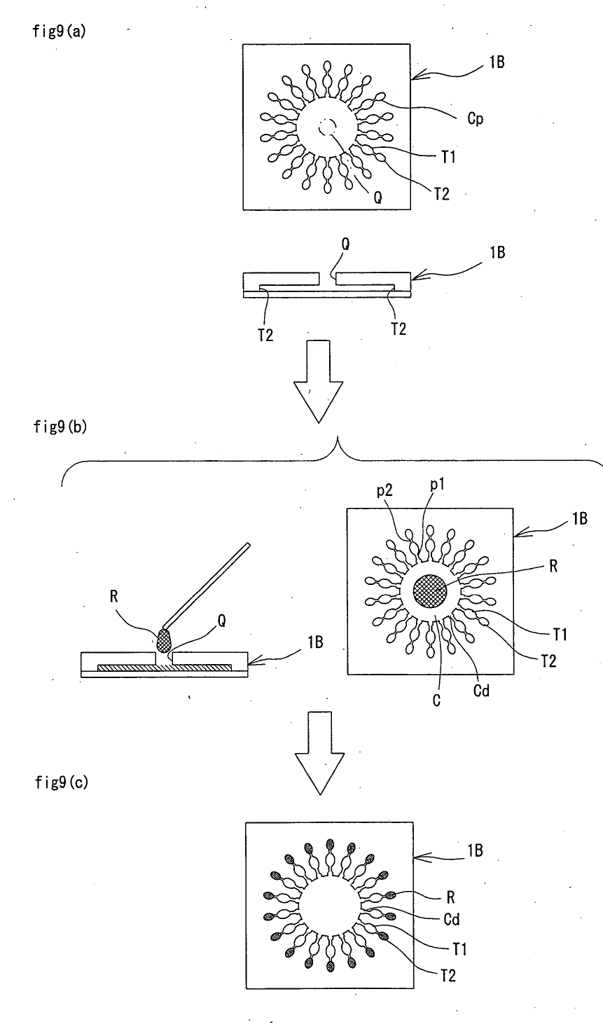

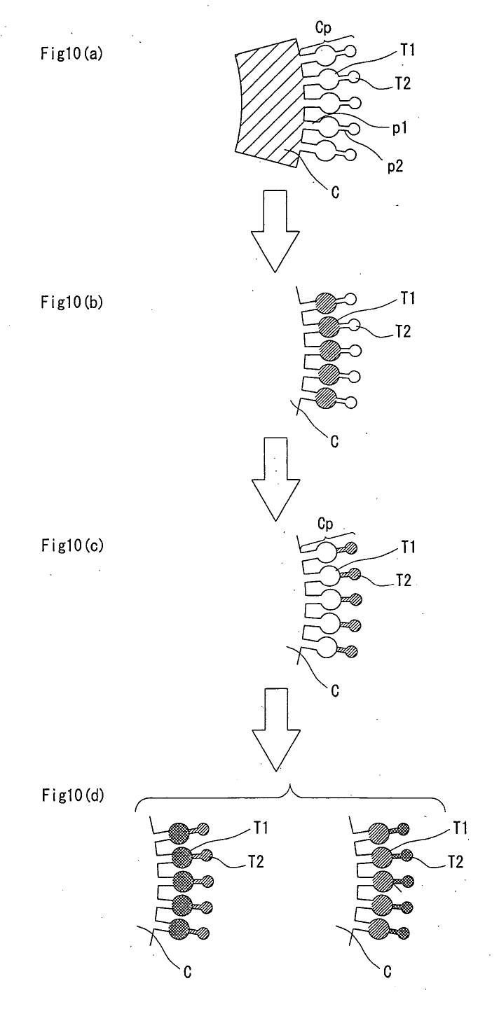

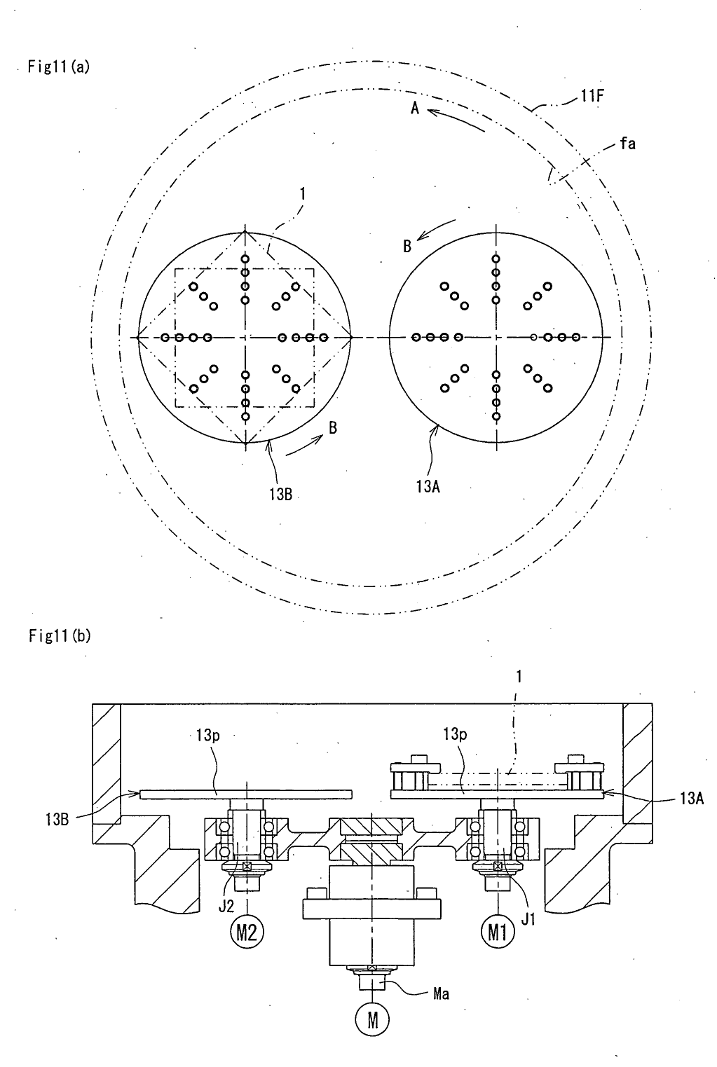

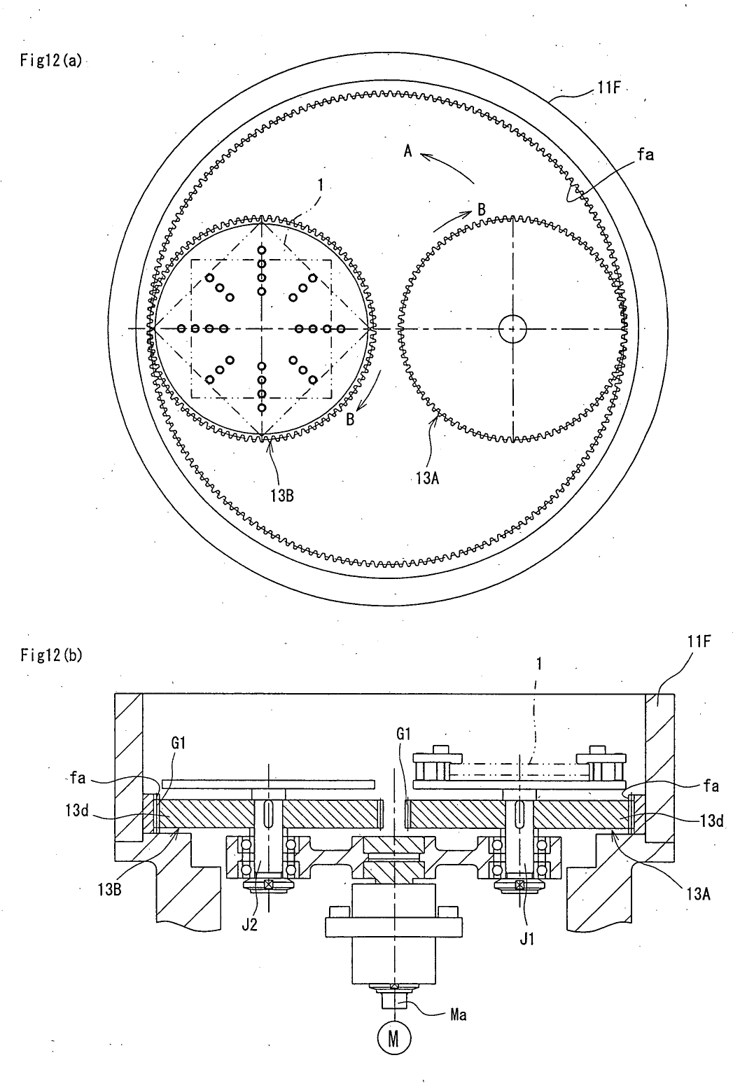

In Example 1, microchips 1B for a sample are used to uniformly dispose in the first detection chambers T1 PCR solutions R that are then moved to the second detection chambers T2, with the result that the PCR solution in a second chamber T2 will avoid contact with adjacent second chambers in which different kinds of primers are disposed fixedly (in a non-contact state), and the PCR solutions R are uniformly disposed quantitatively in the second detection chambers T2 (FIGS. 9(c) and 10(d)). Then, mineral oil that will function as a cover for the PCR solution R is poured onto the solution-dropping portion C and the centrifugal dispenser 11 is subsequently operated. As a result, the microchips 1B mounted on the rotary disks 13A and 13B are subjected to a sun-and-planet rotation making the revolving motion and rotating motion (FIG. 7). At this time, the liquid samples receive the centrifugal force of the rotating motion and that of the revolving motion to form an oil film on the inner side of each PCR solution, thereby breaking the contact thereof with the air and assuming the state wherein the PCR solution is covered with the oil film. To be specific, as shown in FIG. 9, in either the case of performing pouring the PCR solution, operating the centrifugal dispenser, pouring the mineral oil and operating the centrifugal dispenser or the case of pouring the mineral oil, operating the centrifugal dispenser, pouring the PCR solution and operating the centrifugal dispenser, the mineral oil is disposed in the first detection chambers T1 and the PCR solution in the second detection chambers T2 owing to their gravity difference. Incidentally, since the sample R is poured into the second detection chamber T2 as separated, this motion is defined in the present specification as “dispensing motion.” Finally, the microchips for a sample are removed from the rotary disks of the centrifugal dispenser, disposed in position on a heater table that accurately performs the temperature control and controlled in temperature by the PCR amplification method. After the completion of the PCR or at a real time, the detection chambers T2 are fluorescence-detected, and the reaction results are diagnosed.

In Example 1, an SRY gene (the human sex determinating gene) was detected from a human genome DNA. First prepared was a PCR solution (dNTP mixture: 5 μl, 10× Buffer: 5 μl, 25 mM MgCl₂: 8 μl, Amplitaq Gold DNA polymerase: 1 μl, TaqMan primer: 5 μl, Forward primer: 5 μl, Reverse primer: 5 μl, H₂O: 10 μl, 2.5% PVP: 5 μl and Human Male DNA: 1 μl) that was then given rotation drive to dispose the PCR solution in the chambers of the microchips for a sample. The microchips were subsequently placed on a thermal cycler and then subjected to 45 heat cycles, one cycle comprising heating at 95° C. for 5 minutes, reducing the temperature to 60° C. in 15 seconds, heating at 60° C. for 60 seconds and elevating the temperature again to 90° C., thereby amplifying the DNA. Thereafter, a fluorescence microscope was used to measure the fluorescence intensity variation (ex460-490 and em510-550) of each chamber (12 chambers in total). As a result, the fluorescence intensity of the chambers containing the human genome DNA (6 chambers in total) was increased by about 1.84 times on the average as compared with the chambers not containing the human genome DNA (6 chambers in total). This result is shown in FIG. 15 and is substantially the same as the result according to the fluorescence detection process of the conventional real-time PCR method. This means that it has been found to be possible to detect a target gene using the microchip for a sample according to the present invention. FIG. 15 is an explanatory graph showing the results of detection of the SRY gene, in which the solid bar charts indicate the results containing the Human Male DNA (presence of the casting mold) and blank bar charts the results not containing the Human Male DNA (absence of the casting mold).

### EXAMPLE 2

A microchip 1E shown in FIG. 13 was used, in which 25 μl of a blue dye (bromophenol blue) solution was dropped into the central input port Q thereof and given a sun-and-planet rotation, and the revolution per minute (rpm) when all the chambers T1 had been filled with the solution was examined. The microchip 1E fabricated as shown in FIG. 13 had PDMS attached to a silicon wafer cut to 40 mm square by means of oxygen plasma. Four kinds of microchips 1E were fabricated in which the flow paths p2 had a length M5 of 2 mm, a width M6 varied to 1000 μm, 750 μm, 500 μm and 250 μm and a depth of 120 μm. In the four microchips 1E, a length M1 is 30.5 mm and M2 19.3 mm, and the detection chamber T1 has a length M3 of 3 mm and a width M4 of 2 mm.

The experimental results using the centrifugal dispenser 11 were 950 rpm in the case of the microchip having the flow path p2 of the width M6 of 1000 μm, 1050 rpm in the case of the microchip having the flow path p2 of the width M6 of 750 μm, 1520 rpm in the case of the microchip having the flow path p2 of the width M6 of 500 μm and 1850 rpm in the case of the microchip having the flow path p2 of the width M6 of 250 μm, respectively. In addition, all the detection chambers T1 were filled uniformly with the solution.

### COMPARATIVE EXAMPLE 1

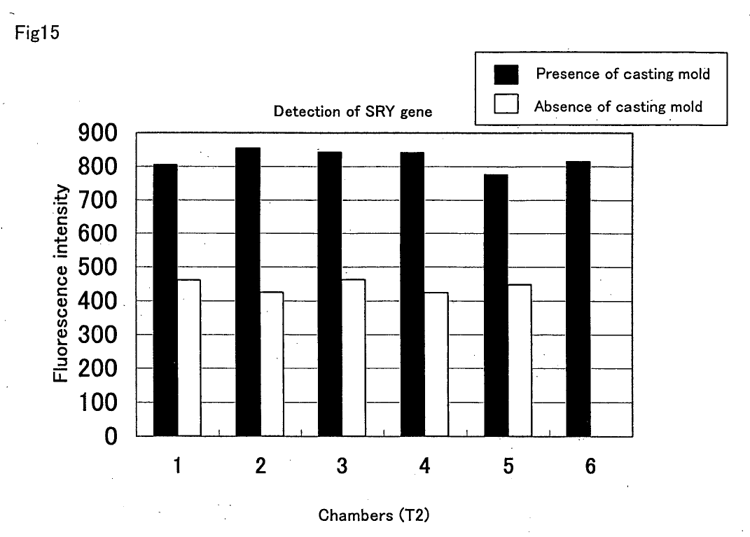

In Comparative Example 1, the microchip 1A of one embodiment of the present invention shown in FIG. 1 was used and given a rotating motion by means of a spin coater (the distance from the rotary shaft to the channel pattern Cp: 8 mm). Though a PCR solution was poured from the input port Q onto the central solution-dropping portion C and the rotation was given by the spin coater, the microchip 1A was disposed as slightly deviated from the central axis of the spin coater. As a result, some deviation of the PCR solution in the channel patterns Cp arose (FIG. 14). The direction of arrow F in FIG. 14 is the direction in which the microchip center is deviated, and FIG. 14 shows that the solution is collected in this direction since the centrifugal force is strongly exerted in this direction. For this reason, there were the chambers filled by one half with the solution and filled with no solution. At the speed of around 8000 rpm, some solutions reached part of the first detection chambers P1 and the other solutions stopped at the flow paths p2. It is conceivable that the deviation in disposition of the microchip on the rotary disk was adversely affected and that the resistance of the PCR solution to enter the minute flow paths was larger than the force of directing the PCR solution outward by means of the centrifugal force of the rotating motion alone.

### COMPARATIVE EXAMPLE 2

In Comparative Example 2, the microchip 1B of one embodiment of the present invention shown in FIG. 2 was used and given a rotating motion by means of a spin coater (the distance from the rotary shaft to the channel pattern Cp: 8 mm). Though a PCR solution was poured from the input port Q onto the central solution-dropping portion C and the rotation was given by the spin coater, the microchip 1B was disposed as slightly deviated from the central axis of the spin coater. This test was conducted at not less than 15000 rpm. As a result, while the PCR solution was disposed in the detection chambers T1 and T2 on one side (one half on one of the right and left sides), it was not disposed in the detection chambers diagonal to the detection chambers having the PCR solution disposed therein by the amount of the deviation from the central axis of the spin coater. Thus, some deviation of the PCR solution in the detection chamber arose because the amount of the solution poured was quantitative. While the PCR solution was disposed in both the detection chambers T1 and T2 in the direction in which the centrifugal force was exerted, it was disposed in one or none of the detection chambers T1 and T2 in the direction in which the centrifugal force was not exerted. In this way, though the PCR solution was in contact with the detection chambers T1 and T2, it or a required amount thereof failed to be disposed in the detection chambers. It was found from this that the slight positional deviation from the center of the spin coater could not dispose the PCR solution uniformly in the detection chambers.

As described in the foregoing, mere impartation of the rotating motion cannot dispose microchips on the rotary disks 13A and 13B at accurate position, but dispose them on the rotary disks at slightly deviated positions, with the result that the sample cannot be uniformly disposed all in the detection chambers T1 and T2, as described in Comparative Examples 1 and 2, with the variation in disposition of the sample in the detection chambers made. On the other hand, as in Examples 1 and 2 using the microchips 1A to 1E for a sample and the method and apparatus according to the embodiments of the present invention, it has been understood that the sample can be uniformly poured as separated (dispensed) in all the detection chambers T1 and T2.

What is claimed is:

1. A microchip used for a method for centrifugally dispensing a liquid sample by giving a revolving motion and a rotating motion to a rotary disk on which the microchip is mounted, comprising a solution-pouring portion at a center thereof onto which the liquid sample is poured and channel patterns extending outward, with the solution-pouring portion as a center, and forming therein flow paths for the liquid sample and detection chambers which constitute portions for examining the liquid sample and in which the liquid sample is centrifugally dispensed.

2. A microchip according to claim 1, wherein the channel patterns extend radially and equidistantly and are wider than the flow paths.

3. A method for centrifugally dispensing a liquid sample comprising the steps of using a microchip comprising a solution-pouring portion at a center thereof onto which the liquid sample is poured and channel patterns extending outward, with the solution-pouring portion as a center, and forming therein flow paths for the liquid sample and detection chambers which constitute portions for examining the liquid sample and in which the liquid sample is centrifugally dispensed and giving a revolving motion and a rotating motion to a rotary disk on which the microchip is mounted, thereby centrifugally dispensing the liquid sample in the detection chambers.

4. A centrifugal dispenser using a microchip comprising a solution-pouring portion at a center thereof onto which the liquid sample is poured and channel patterns extending outward, with the solution-pouring portion as a center, and forming therein flow paths for the liquid sample and detection chambers which constitute portions for examining the liquid sample and in which the liquid sample is centrifugally dispensed, which dispenser comprises a rotary disk on which the microchip is mounted, means for revolving the rotary disk about a shaft and means for rotating the rotary disk about another shaft of the rotary disk.

5. A centrifugal dispenser according to claim 4, wherein the means for revolving the rotary disk comprises a drive means and an arm which is rotated about the shaft by the drive means and on which the rotary disk is mounted, and the means for rotating the rotary disk comprises a gear formed on a periphery of the rotary disk and another gear formed at a center of the arm as suspended from the center for engaging with the gear, or outside revolving motion, wherein the revolving of the rotary disk is given by the rotating of the arm and the rotating of the rotary disk is given by the engaging of the gear with the another gear.
